(19) United States
(12) Patent Application Publication
(10) Pub. No.: US 2013/0329639 A1
(43) Pub. Date: Dec. 12, 2013

(54) CONNECTION MANAGEMENT FOR MULTI OPERATOR SELECTION

(71) Applicant: QUALCOMM Incorporated, San Diego, CA (US)

(72) Inventors: Richard Dominic WIETFELDT, San Diego, CA (US); Dong-an ZHANG, San Diego, CA (US)

(21) Appl. No.: 13/916,040

(22) Filed: Jun. 12, 2013

Related U.S. Application Data
(60) Provisional application No. 61/658,888, filed on Jun. 12, 2012.

(51) Int. Cl. H04W 88/06

(52) U.S. Cl. CPC H04W 88/06
USPC 370/328

(57) ABSTRACT

A user equipment (UE) may flexibly or dynamically access one or more network operators via one or more subscriber identity modules (SIMs) (or virtual SIMs) in the mobile device. Each SIM provides authentication/access to a single network operator, and multiple SIMs will therefore enable multiple network operator accesses. The authentication may be based on one or more physical SIMs and/or virtual SIMs. A connectivity engine in the UE allows for dynamic selection and/or authentication of network operators, e.g., wireless/mobile network operators or carriers, and their corresponding radio access technologies (RATs).

### CROSS-REFERENCE TO RELATED APPLICATION

This application claims the benefit under 35 U.S.C. §119(e) to U.S. Provisional Patent Application No. 61/658,888, entitled, CONNECTION MANAGEMENT FOR MULTI OPERATOR SELECTION, filed on Jun. 12, 2012, in the names of WIETFELDT, et al., the disclosure of which is expressly incorporated by reference herein in its entirety.

### BACKGROUND

1. Field

Aspects of the present disclosure relate generally to wireless communication systems, and more particularly to connection management for multi operator selection.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

According to one aspect of the present disclosure, a method for wireless communication includes associating a plurality of subscriber identity modules (SIMs) of a user equipment (UE) with a plurality of radios of the UE. The method may also include communicating with the UE based at least in part on the associating.

According to another aspect of the present disclosure, an apparatus for wireless communication includes means for associating a plurality of subscriber identity modules (SIMs) of a user equipment (UE) with a plurality of radios of the UE. The apparatus may also include means for communicating with the UE based at least in part on the associating.

According to one aspect of the present disclosure, a computer program product for wireless communication in a wireless network includes a non-transitory computer readable medium having program code recorded thereon. The program code includes program code to associate a plurality of subscriber identity modules (SIMs) of a user equipment (UE) with a plurality of radios of the UE. The program code also includes program code to communicate with the UE based at least in part on the associating.

According to one aspect of the present disclosure, an apparatus for wireless communication includes a memory and a processor(s) coupled to the memory. The processor(s) is configured to associate a plurality of subscriber identity modules (SIMs) of a user equipment (UE) with a plurality of radios of the UE. The processor(s) is further configured to communicate with the UE based at least in part on the associating.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of an access network.

FIG. 3 is a diagram illustrating an example of a downlink frame structure in LTE.

FIG. 4 is a diagram illustrating an example of an uplink frame structure in LTE.

FIG. 5 is a diagram illustrating an example of a radio protocol architecture for the user and control plane.

FIG. 6 is a diagram illustrating an example of an evolved Node B and user equipment in an access network.

FIGS. 7A-7I illustrate example network operator selection systems based on a connectivity engine implementation according to aspects of the present disclosure.

FIG. 8 illustrates a system for selecting between network operators based on one or more modem configurations.

FIG. 9 illustrates a system for selecting between network operators based on a connectivity engine.

FIG. 10 illustrates a network operator selection implementation according to one aspect of the present disclosure.

FIG. 11 is a block diagram illustrating a dynamic network operator selection method according to one aspect of the present disclosure.

FIG. 12 is a diagram illustrating an example of a hardware implementation for an apparatus employing a dynamic network operator selection system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Aspects of the telecommunication systems are presented with reference to various apparatus and methods. These apparatus and methods are described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

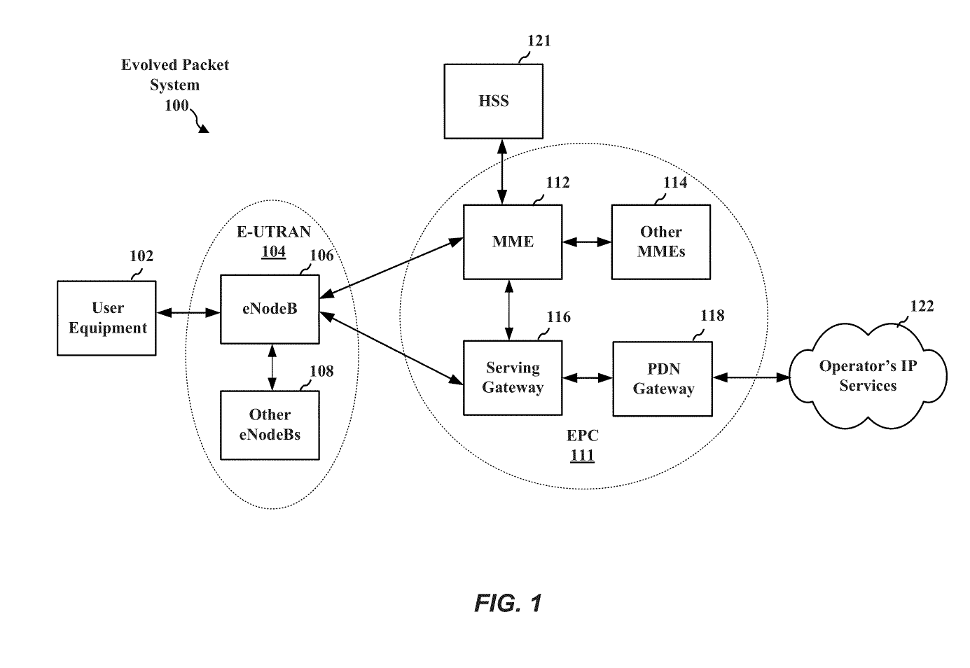

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 111, a Home Subscriber Server (HSS) 121, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNodeB) 106 and other eNodeBs 108. The eNodeB 106 provides user and control plane protocol terminations toward the UE 102. The eNodeB 106 may be connected to the other eNodeBs 108 via an X2 interface (e.g., backhaul). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 111 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected by an S1 interface to the EPC 111. The EPC 111 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 111. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

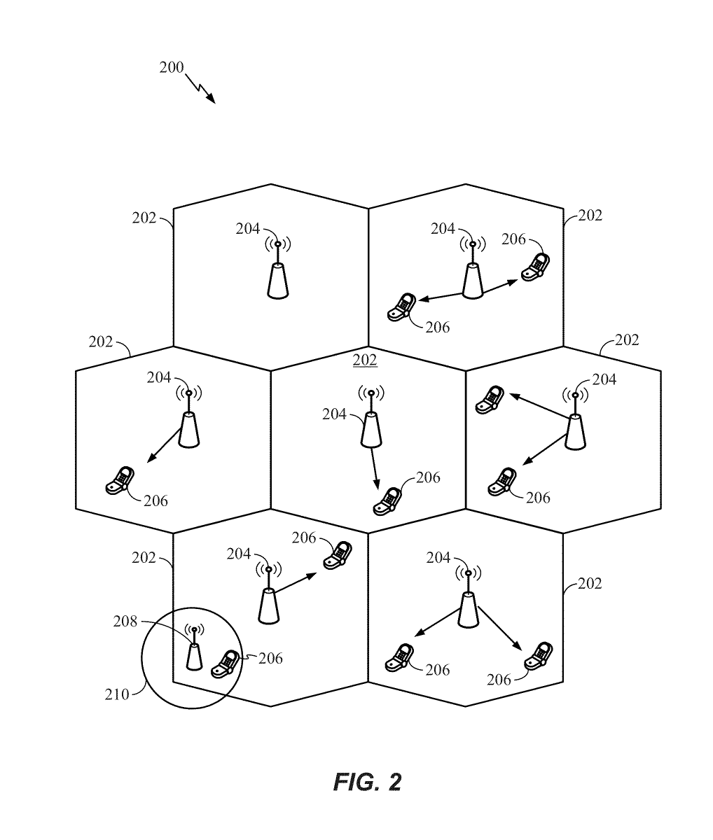

FIG. 2 is a diagram illustrating an example of an access network 200 in an LTE network architecture. In this example, the access network 200 is divided into a number of cellular regions (cells) 202. One or more lower power class eNodeBs 208 may have cellular regions 210 that overlap with one or more of the cells 202. A lower power class eNodeB 208 may be referred to as a remote radio head (RRH). The lower power class eNodeB 208 may be a femto cell (e.g., home eNodeB (HeNodeB)), pico cell, or micro cell. The macro eNodeBs 204 are each assigned to a respective cell 202 and are configured to provide an access point to the EPC 111 for all the UEs 206 in the cells 202. There is no centralized controller in this example of an access network 200, but a centralized controller may be used in alternative configurations. The eNodeBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the downlink and SC-FDMA is used on the uplink to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNodeBs 204 may have multiple antennas supporting MIMO technology. The use of MIMO technology enables the eNodeBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the downlink. The spatially precoded data streams arrive at the UE(s) 206 with different spatial signatures, which enables each of the UE(s) 206 to recover the one or more data streams destined for that UE 206. On the uplink, each UE 206 transmits a spatially precoded data stream, which enables the eNodeB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PAPR).

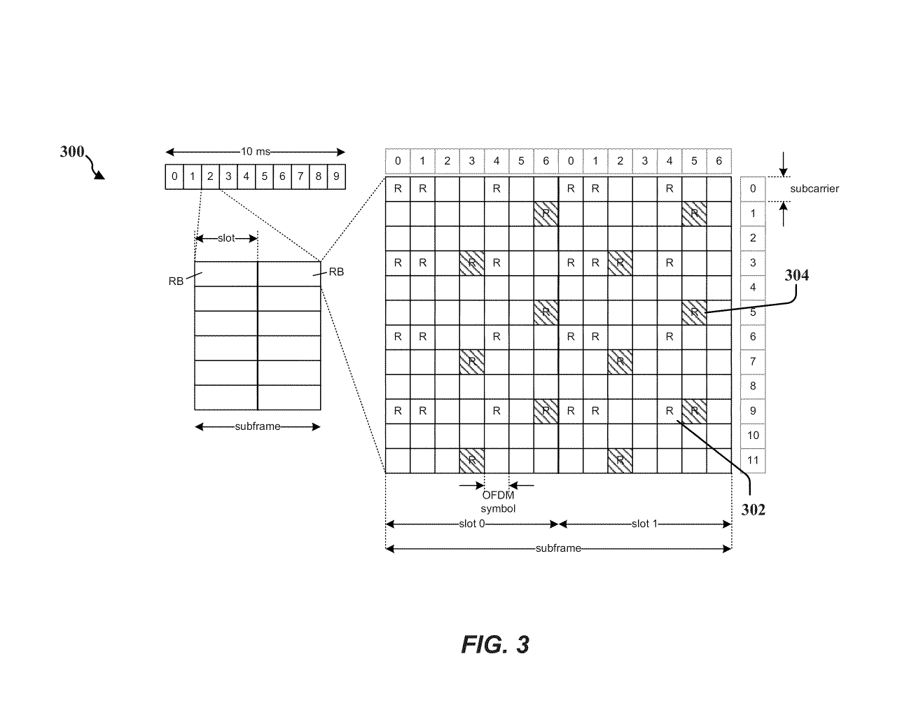

FIG. 3 is a diagram 300 illustrating an example of a downlink frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include downlink reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

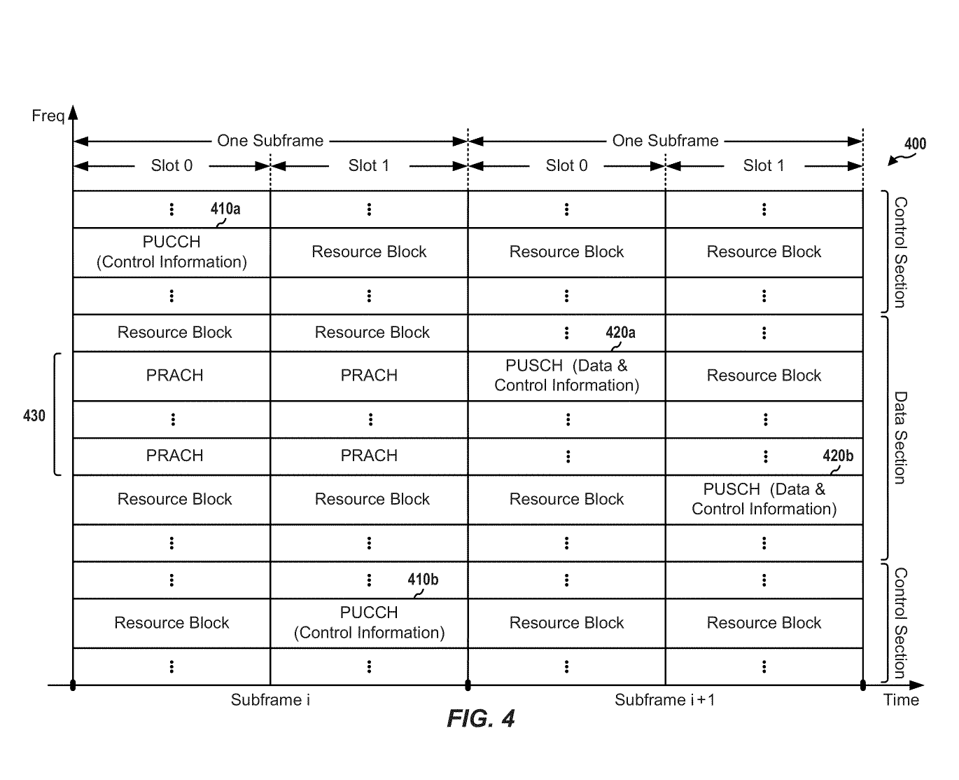

FIG. 4 is a diagram 400 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 410a, 410b in the control section to transmit control information to an eNodeB. The UE may also be assigned resource blocks 420a, 420b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 430. The PRACH 430 carries a random sequence and cannot carry any uplink data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

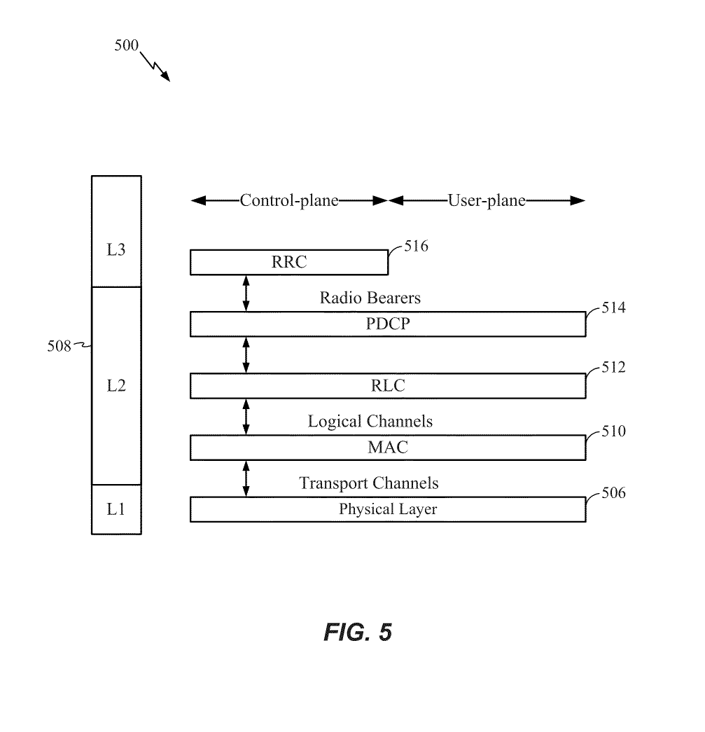

FIG. 5 is a diagram 500 illustrating an example of a radio protocol architecture for the user and control planes in LTE. The radio protocol architecture for the UE and the eNodeB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNodeB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNodeB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNodeBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNodeB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNodeB and the UE.

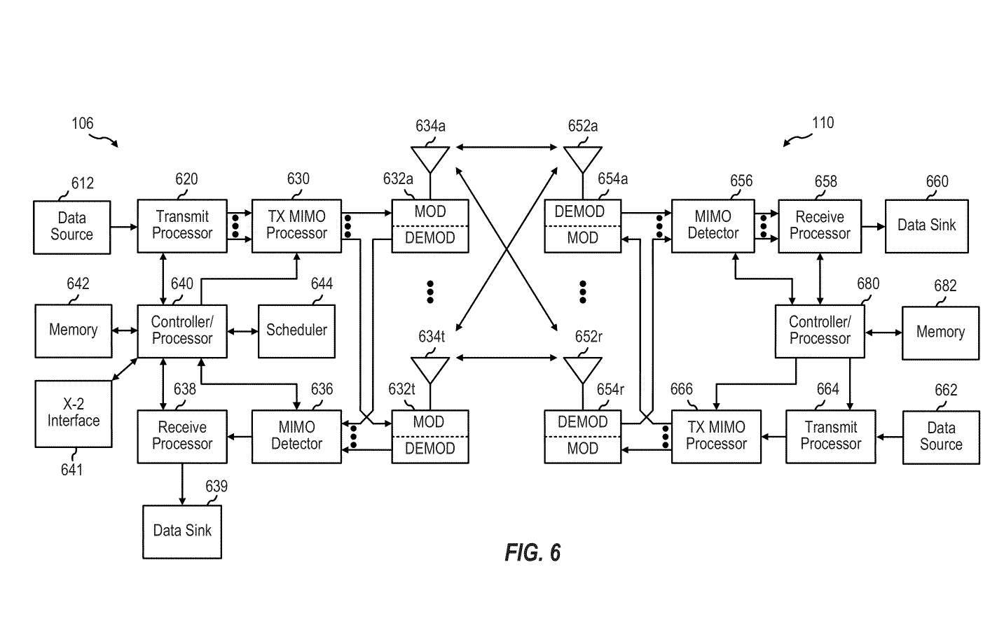

FIG. 6 shows a block diagram of a design of a base station/eNodeB 106 and a UE 102, which may be one of the base stations/eNodeBs and one of the UEs in FIG. 1 or FIG. 2. For example, the base station 106 may be the macro eNodeB 204 in FIG. 2, and the UE 102 may be the UE 206. The base station 106 may also be a base station of some other type. The base station 106 may be equipped with antennas 634a through 634t, and the UE 102 may be equipped with antennas 652a through 652r.

At the base station 106, a transmit processor 620 may receive data from a data source 612 and control information from a controller/processor 640. The control information may be for the PBCH, PCFICH, PHICH, PDCCH, etc. The data may be for the PDSCH, etc. The processor 620 may process (e.g., encode and symbol map) the data and control information to obtain data symbols and control symbols, respectively. The processor 620 may also generate reference symbols, e.g., for the PSS, SSS, and cell-specific reference signal. A transmit (TX) multiple-input multiple-output (MIMO) processor 630 may perform spatial processing (e.g., precoding) on the data symbols, the control symbols, and/or the reference symbols, if applicable, and may provide output symbol streams to the modulators (MODs) 632a through 632t. Each modulator 632 may process a respective output symbol stream (e.g., for OFDM, etc.) to obtain an output sample stream. Each modulator 632 may further process (e.g., convert to analog, amplify, filter, and upconvert) the output sample stream to obtain a downlink signal. Downlink signals from modulators 632a through 632t may be transmitted via the antennas 634a through 634t, respectively.

At the UE 102, the antennas 652a through 652r may receive the downlink signals from the base station 106 and may provide received signals to the demodulators (DEMODs) 654a through 654r, respectively. Each demodulator 654 may condition (e.g., filter, amplify, downconvert, and digitize) a respective received signal to obtain input samples. Each demodulator 654 may further process the input samples (e.g., for OFDM, etc.) to obtain received symbols. A MIMO detector 656 may obtain received symbols from all the demodulators 654a through 654r, perform MIMO detection on the received symbols if applicable, and provide detected symbols. A receive processor 658 may process (e.g., demodulate, deinterleave, and decode) the detected symbols, provide decoded data for the UE 102 to a data sink 660, and provide decoded control information to a controller/processor 680.

On the uplink, at the UE 102, a transmit processor 664 may receive and process data (e.g., for the PUSCH) from a data source 662 and control information (e.g., for the PUCCH) from the controller/processor 680. The processor 664 may also generate reference symbols for a reference signal. The symbols from the transmit processor 664 may be precoded by a TX MIMO processor 666 if applicable, further processed by the modulators 654a through 654r (e.g., for SC-FDM, etc.), and transmitted to the base station 106. At the base station 106, the uplink signals from the UE 102 may be received by the antennas 634, processed by the demodulators 632, detected by a MIMO detector 636 if applicable, and further processed by a receive processor 638 to obtain decoded data and control information sent by the UE 102. The processor 638 may provide the decoded data to a data sink 639 and the decoded control information to the controller/processor 640. The base station 106 can send messages to other base stations, for example, over an X2 interface 641.

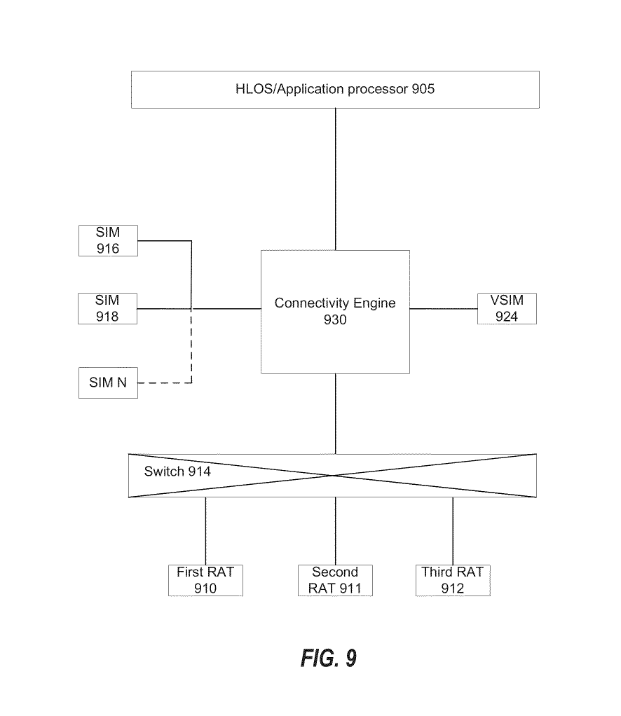

The controllers/processors 640 and 680 may direct the operation at the base station 106 and the UE 102, respectively. The processor 640/680 and/or other processors and modules at the base station 106/UE 102 may perform or direct the execution of the functional blocks illustrated in FIG. 9, and/or other processes for the techniques described herein. The memories 642 and 682 may store data and program codes for the base station 106 and the UE 102, respectively. A scheduler 644 may schedule UEs for data transmission on the downlink and/or uplink.

LTE-Advanced UEs use spectrum in up to 20 MHz bandwidths allocated in a carrier aggregation of up to a total of 100 MHz (5 component carriers) used for transmission in each direction. Generally, less traffic is transmitted on the uplink than the downlink, so the uplink spectrum allocation may be smaller than the downlink allocation. For example, if 20 MHz is assigned to the uplink, the downlink may be assigned 100 MHz. These asymmetric FDD assignments will conserve spectrum and are a good fit for the typically asymmetric bandwidth utilization by broadband subscribers.

### Connection Management for Multi Operator Selection

A subscriber identity module (SIM) or universal subscriber identity module (USIM) is a unique identifier that is associated with a mobile communication device. These SIMs are commonly associated with a telephone number. Conventional mobile devices or UEs have a single SIM. Such conventional single SIM mobile device, however, may suffer from network issues at a given location and time, including network coverage (e.g., poor operator coverage in a region due to not enough towers), network congestion (e.g., too many users), network interference (e.g., coexistence, where one radio of a device (such as WiFi) may be configured to coexist with another radio of the device of the device where simultaneous operation of the radios may result in in-device interference). The conventional single SIM mobile device may also be limited by cost issues due to high data charges, roaming charges, etc., by unified billing disadvantage when there is a desire is to separate work and personal usage charges, etc. Further, a device with a single SIM may be limited in selection of different operators at a specific location and time.

With the development and deployment of various mobile communication systems, multiple-SIM mobile devices designed to accommodate multiple SIM identities/cards have been developed. An example of a multiple SIM mobile device is a dual SIM UE. The dual-SIM UE allows the use of two services or operators by attaching two SIM cards without the need to carry two mobile devices or to change the SIM cards alternately. However, a user may not know which SIM card is used when receiving information, e.g., an incoming call, or transmitting information, e.g., an outgoing call. Thus, there is a desire to implement a system for operator/network selection, which can improve operator/network access, cost, quality, etc. A UE may also be configured to implement a virtual SIM (VSIM) configuration. In a VSIM configuration, a UE employs a trusted or secure element that provides subscription to a network without a physical SIM card. The VSIM configuration may also support remote management of subscriptions. The VSIM configuration does not specify a physical SIM and may perform dynamic provisioning in software and/or dedicated hardware. A dual SIM UE may be dual SIM-dual standby (DSDS), which means the UE is limited to connecting to one network at a time. Alternatively, a UE may be dual-SIM-dual active (DSDA), which means the UE may connect to multiple networks simultaneously. When there is a DSDA configuration, the application to network mapping may be accomplished concurrently. A UE may also be configured with more than two SIMs where more than two SIMs are active at the same time, for example, triple-SIM-triple active (TSTA), etc. The teachings of this disclosure may apply for a variety of configurations of multiple SIMs and corresponding activity.

One aspect of the disclosure allows for flexibly or dynamically accessing one or more network operators via one or more SIMs (or virtual SIMs) in the mobile device. Each SIM provides authentication/access to a single network operator, and multiple SIMs will therefore enable multiple network operator accesses. The authentication may be based on one or more physical SIMs and/or virtual SIMs. One or more authenticated network operators, e.g., wireless/mobile network operators or carriers, and their RATs may be dynamically selected. For example, the network operator may be specified or selected in conjunction with one or more RATs. This feature allows for a granular selection of one or more RATs for a given network operator.

In one aspect of the disclosure, the selection of the network operator may be based on a policy and condition of the network and/or the UE. The policy may be based on a policy file stored in the UE, which may be independent of the operator in some aspects. In one aspect, the policy file may be received and/or updated by the UE in accordance with an over the air (OTA) implementation or through a wired connection. The policy file may also be updated locally. The policy may indicate configurations for SIM selection based on various factors discussed in the present disclosure.

In some aspects of the present disclosure, the dynamic selection of operators and/or RATs is based on conditions such as in-device radio frequency coexistence, interference across UEs, especially in an area that is crowded by UEs, power resources (e.g., associated with the selection of different network operators for power savings or power consumption) and other parameters associated with throughput, efficiency and the like. These conditions are generally referred to as device (such as UE) conditions. Regarding in-device radio frequency coexistence, LTE communication may interfere with WLAN communications. For example, a network operator may not be aware of in-device coexistence issues and may continue to communicate on a particular frequency even though the UE may be experiencing interference between different RATs in the UE. In other circumstances, the network may be reluctant to change the frequency of communication for a single UE. In this situation, the UE or the connectivity engine of the UE may dynamically select a different network operator and/or RAT based on the coexistence condition of the UE. Similarly, the UE may dynamically select a network operator and/or RAT based on interference between UEs.

Further, the UE may dynamically select a network operator and/or RAT to conserver power resources. For example, a UE may dynamically select a network operator based on the proximity of a corresponding base station associated with the network operator. The UE may favor a base station that is closest to the UE in order to reduce transmission power. Thus, even though the UE may not have the feature to select between base stations for a given network operator, the UE can sense (based on measurement parameters such as signal strength) whether communicating with a different base station associated with a different network operator may improve the UEs power resources. Based on the sensing, the UE may dynamically select the different network operator to improve the power resources of the UE. The selection may be based on whether the measurement parameter meets a threshold value.

Further, the UE may dynamically select the network operator and/or RAT to conserver power resources based on RAT-specific power consumption. The RAT-specific power consumption is applicable when different SIMs corresponding to different RATs which different power consumption profiles. For example, a 4G LTE RAT operated by Operator 1 may have higher power consumption than a 3G EV-DO RAT operated by Operator 2. The selection of operators can therefore be made based on the Operator that can provide the more power efficient RAT.

In some aspects, the dynamic network operator selection is based on network conditions, such as end-to-end quality of service, local interference, local link congestion, internet connectivity and other network related conditions. The network may be a wireless network to one or more base stations, core of the operator or carrier and/or the internet. The quality of service parameter associated with the network is referred to as end-to-end quality of service (e.g., quality of service from the UE to a server supporting a website). The end-to-end quality of service of a network operator is evaluated against that of a different network operator and one of the network operators and/or RAT is selected based on the evaluation. The dynamic selection in this case may be based on whether policy associated with the UE or network allows for such a selection. The other network condition is local interference and congestion. In this case, if one network operator provides a better network, in terms of local interference and congestion, than a different network operator, then the UE may dynamically select the better network operator.

Such dynamic network operator selection (also called access redundancy) allows a user to manage cost of network usage and encourages operator service competition. The dynamic network operator selection may also improve bandwidth and quality of service, particularly with respect to advanced network resource intensive applications such as voice over internet protocol (VoIP), internet protocol television (IPTV), gaming, and the like. The dynamic network operator selection allows for user access redundancy implementations that may improve network coverage and reduce network congestion and network interference. In particular, the dynamic network operator selection implementation improves network fading/interference environments and avoids network congestion by applying time of day, location, roaming options, etc., via operator selection. Other benefits of the dynamic network operator selection include WiFi offload efficiency to wired backhaul networks for the different operator networks and reduced power consumption by selecting a closest base station amongst available network operators.

In one aspect of the disclosure, a launched application may be mapped to one or more radio access technologies (RATs)/network operators. A wireless communication device or UE may include a number of RATs to support communication with different wireless networks. For example, the radio technologies may include a wide area network (e.g., third generation partnership project (3GPP) long-term evolution (LTE) or 1× radio transmission technology (1×)), wireless local area network (WLAN), Bluetooth, and/or the like. The multi SIM implementation allows for mapping to multiple operators and RATs for launching a single application. The application may be a voice application, a data application or both. DSDA implementation provides concurrent network access where the connectivity engine may route a first application to the first operator and the second application to a second network operator.

In one aspect of the disclosure, connection management for multi-operator selection is described. To manage the connection for multi-operator selection a connectivity engine or connection manager identifies a best or improved RAT connection to a network operator that meets a UE requirement (e.g., application requirements, device state, etc.) The connectivity engine leverages operator diversity enabled by a virtual SIM or multiple SIMs/operator subscriptions. The ability to dynamically select operator(s) enables improvements in user experience with respect to features such as cost, bandwidth, quality of service, network coverage, network congestion, network interference, WiFi offload efficiency, device power consumption and the like.

Operator selection driven by one or more of these features can be implemented in the connectivity engine, or in other implementations such as connection managers. Connectivity engines can include profiles to guide network operator selection.

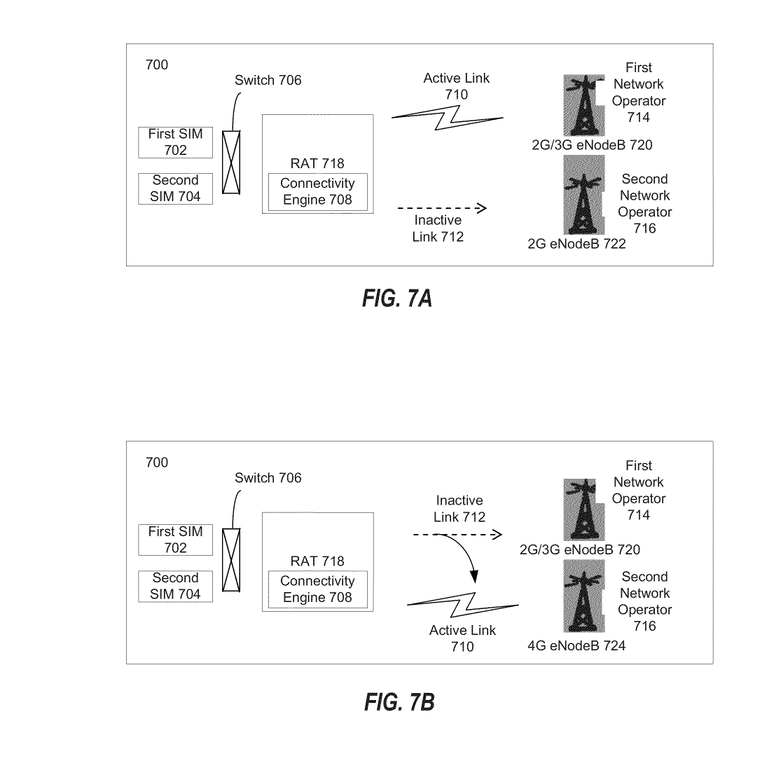

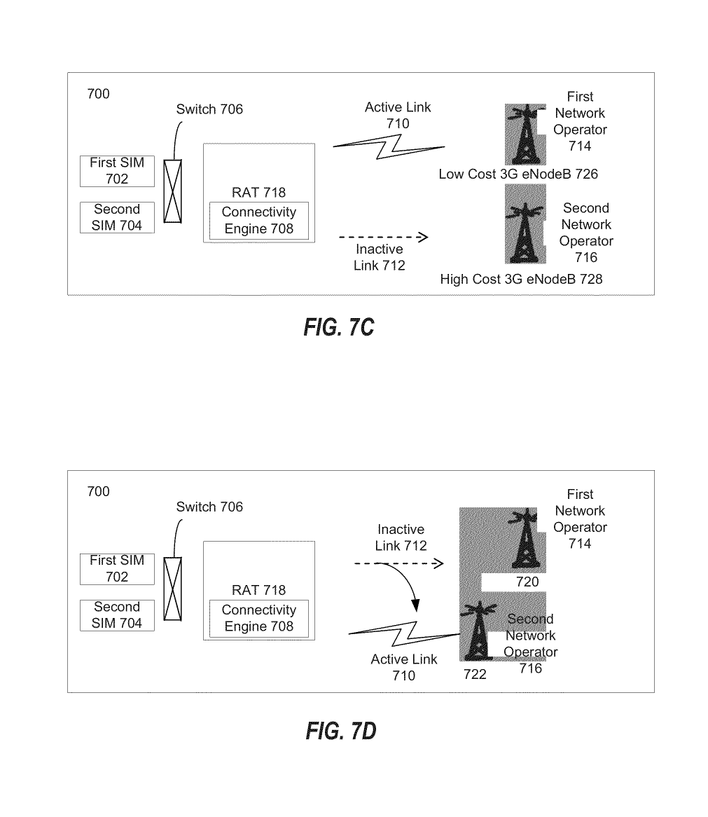

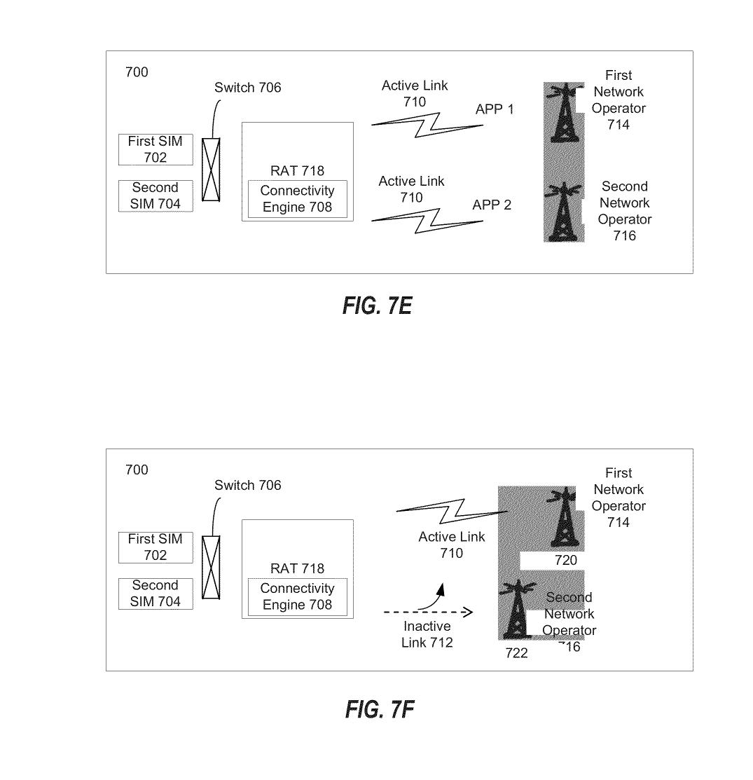

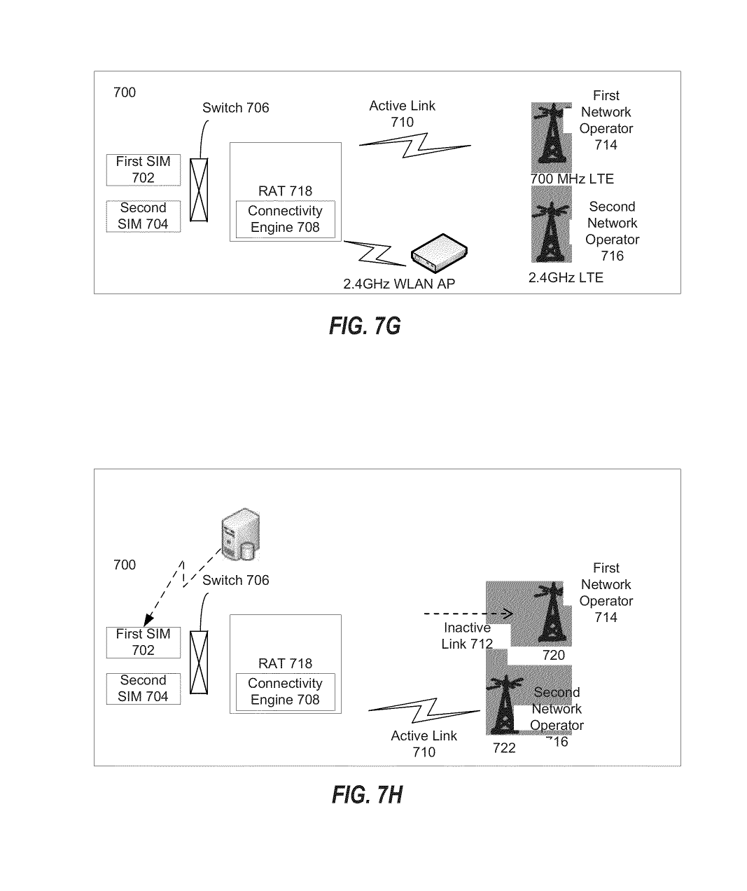

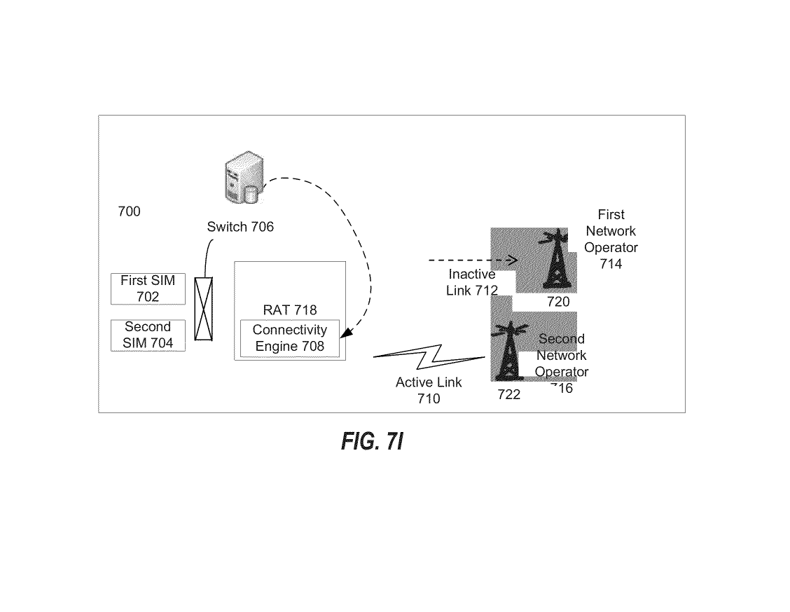

FIGS. 7A-7I illustrate network operator selection systems based on a connectivity engine implementation according to some aspects of the present disclosure. Each network operator selection system 700 incorporates a UE (e.g., UE 102) including a first SIM 702, a second SIM 704, a switching device 706, and a RAT device 718 having a connectivity engine 708. The network operator selection system 700 also includes a first eNodeB associated with a first network operator 714, a second eNodeB associated with a second network operator 716, an active link 710 and an inactive link 712. The first SIM 702 and the second SIM 704 are coupled to a switching device 706 (e.g., switch) to switch between the first and second SIMs 702 and 704 according to a connectivity engine implementation.

The connectivity engine 708 may be configured for dual SIM dual standby (DSDS) or dual SIM dual active (DSDA) UE implementations. The DSDA and DSDS implementation in conjunction with the connectivity engine implementation enables two concurrent network operators in the UE. DSDS implementation provides the ability to have two active SIM simultaneously, using only one RAT device (e.g., transceiver). In the DSDS implementation, the UE can be limited to a single active transceiver on a network access where specific application to a specific network is not enabled. For example, the connectivity engine 708 can route a first application to a first network operator 714 and a second application to the same network operator. As already noted, in DSDA implementations, a connectivity engine may be configured to route a first application to a first network operator 714 and a second application to a second network operator 716 concurrently. In one aspect of the disclosure a connectivity engine 708 may associate applications with operators (e.g. a first network operator navigator is only available on the first network operator), but also supports common applications (e.g. browser) independent of the operator.

In the example of FIG. 7A, the first eNodeB 720 is configured for second (2G) and third generation (3G) wide area networks while the eNodeB 722 is configured for a second generation (2G) wide area network. In this example implementation, the connectivity engine 708 is configured to select a network operator with the highest bandwidth or quality of service, i.e., first network operator 714 associated with the eNodeB 720 configured for third generation wide area network. As a result of the selection, the UE 102 communicates with the first network operator 714 via the active link 710. The highest bandwidth may be the highest end-end bandwidth to meet the operational specification of some applications.

In the example of FIG. 7B, the eNodeB 720 is configured for a second and third generation wide area network while the eNodeB 724 is configured for a fourth generation (4G) wide area network. In this implementation, the connectivity engine 708 is configured to select a network operator with the highest throughput RAT to meet the demands for applications such as voice over internet protocol, internet protocol television, video games and the like. In this case, the second network operator 716 associated with the eNodeB 724 configured for fourth generation wide area network is selected because it provides the highest throughput. As a result, of the selection, the UE 102 communicates with the second network operator 716 via the active link 710.

In the example of FIG. 7C, the eNodeB 726 is associated a low cost third generation wide area network while the eNodeB 728 is associated with a high cost second generation wide area network. In this implementation, the connectivity engine 708 is configured to select a network operator with the lowest cost (e.g., lowest plan or data roaming service). In this case, the first network operator 714 associated with the eNodeB 726 provides the lowest cost and is therefore selected. As a result, of the selection, the UE 102 communicates with the first network operator 714 via the active link 710. For example, the networks operators with better cost rates may be dynamically selected over other network operators. The cost rate of a network operator may be predetermined and subsequently updated dynamically over a time period, or once per connection or based on some entity that tracks the cost. The operator pricing information may be available through a related network/cloud service.

In the example of FIG. 7D, the eNodeB 720 is further from a UE 102 associated with the connectivity engine 708 than the eNodeB 722. In this implementation, the connectivity engine 708 is configured to select a network operator that is closest to the UE 102 to save transmit power, reduce battery drainage, or to avoid possible fading/interference condition. In this case, the second network operator 716 associated with the closest eNodeB 722 is selected. As a result, of the selection, the UE 102 communicates with the second network operator via the active link 710.

FIG. 7E illustrates network operator selection for different applications based on a connectivity engine implementation according to some aspects of the present disclosure. For example, the connectivity engine 708 can route a first application, APP 1, to a first network operator 714 and a second application, APP 2, to a second network operator 716. The selection of the network operator for each application may be based on applications to operator/RAT mapping policy. The operator/RAT mapping policy may be implemented to select one or more RATs for a given operator. The mapping may be specific to the application and may be based on a policy. For example, first network operator may be selected for launching a browser, while a different network operator may be selected for a text message. The selection of the network operator may be based on a look-up table or on some other dynamic implementation that associates an application with a network operator. The look-up table may be stored in the policy file or implemented in conjunction with the policy file and may be implemented statically or dynamically.

FIG. 7F illustrates network operator selection based on time of day and location of the UE. For example, the connectivity engine 708 may select the first network operator 714, based on the time of the day and/or the location of the UE, to avoid congestion and interference. The time of the day may be a selection based on off peak hours of the day as well as peak hours of the day. An example of location based selection is selection based on whether the UE is in the user's office, a mall or home. In some aspects, the selection may be operator driven, such as operator-driven WiFi selection or operator driven femto selection.

FIG. 7G illustrates network operator selection based on interference across devices and/or in-device radio frequency coexistence. In this situation, the UE or the connectivity engine of the UE may dynamically select a different network operator and/or RAT based on coexistence condition of the UE. Similarly, the UE may dynamically select a network operator and/or RAT based on interference between UEs. For example, a communication between a RAT 718 and a 2.4 GHz WLAN access point may be subject to interference from communication between the UE and the second network operator 716, which is operating at a frequency of 2.4 GHz LTE. Thus selecting the operator 716 operating at 2.4 GHz LTE for communication may result in slow data rate and degraded user experience. In this situation, the connectivity engine 708 may select the low frequency band (700 MHz) to avoid the coexistence problems.

FIG. 7H illustrates network operator selection and/or authentication based on a VSIM. As noted, the VSIM may not specify a physical SIM and may perform dynamic provisioning in software and/or dedicated hardware. The VSIM or a function of the VSIM may be configured to perform dynamic provisioning in software and/or dedicated hardware. The dynamic provisioning includes dynamic and flexible subscription provisioning. The VSIM or a function of the VSIM accounts for improved biometric subscriber authentication.

FIG. 7I illustrates network operator selection associated with multi-operator dynamic multi-policy provisioning. For example, the Operator selection may be based on one or more policies per operator, and one or more overall user policies that manage overall UE behavior. In this scenario, multi-operators may send policy files to the same UE to provision the UE. The policy files may be sent to the UE over the air during a provisioning step and/or the UE can be provisioned locally.

Although each operator may have its own access network discovery and selection function (ANDSF) policy file, or multiple operators may be inserted into a common ANDSF policy file, the connectivity engine may manage a common user policy. The management of the common user policy can be accomplished by the connectivity engine (independent of or with knowledge of all operators) to meet user requirements, for example, power management, coverage/location and time of day management, cost management, etc.

To manage connections in a multi-SIM UE, a UE may include a connectivity engine to facilitate selection associated with public and operator managed wireless network access. To manage a multi SIM device a UE 102 may be configured to share multiple modems or modem ports. The modems can be implemented on a platform that includes two or more independent modems. Each modem may be associated with multiple radio access technology (RAT) devices and multiple SIMs. As a result, the multiple SIMs can be switched while sharing a same modem.

The connectivity engine enables the UE to use SIM1, for example, for City A and SIM2 for City B in order to reduce the roaming fee and long distance call fee. The connectivity engine may also enable UE to use SIM1 for operator A with certain business applications, and SIM2 for operator B in personal usage. In addition, the connectivity engine enables UE to use SIM1 for the full phone feature, while limiting SIM2 for data services. Further, the connectivity engine in conjunction with a coexistence manager may reduce coexistence interference or other interference by selecting operator channels with less interference. Furthermore, the connectivity engine may serve as a central location for implementing Emergency Call requirement logic. The logic may be configurable according to an implementation associated with the connectivity engine.

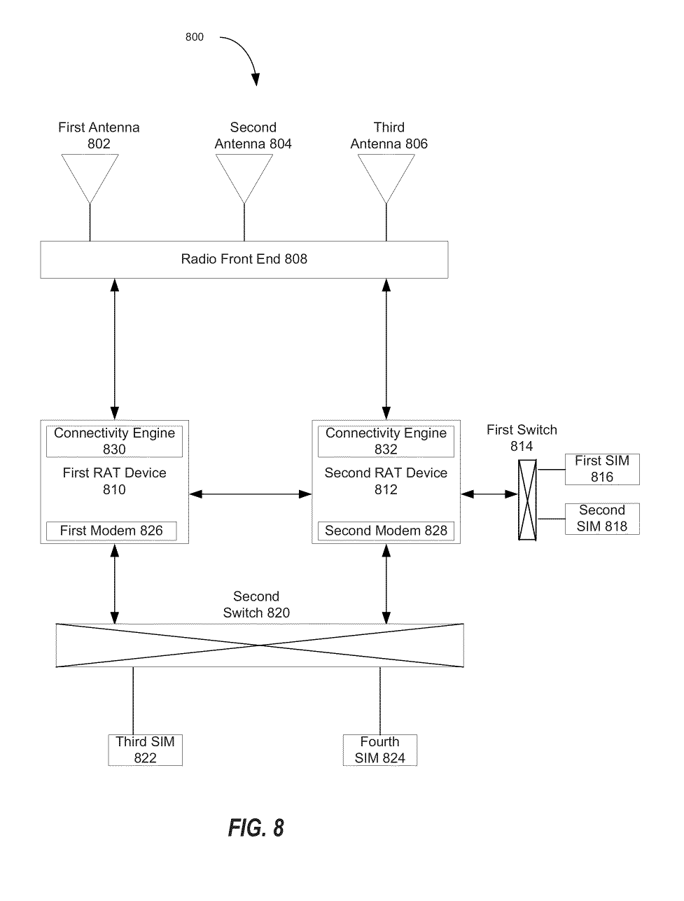

FIG. 8 illustrates a system 800 for selecting between network operators based on one or more modem configurations. The system 800 for selecting between network operators can be implemented in a UE 102. The system 800 includes a first and a second RAT devices (e.g., a transceivers or single chip devices) 810 and 812, a radio front end device 808, a first SIM 816, a second SIM 818, a third SIM 822, a fourth SIM 824, a first switch 814 and a second switch 820. The radio front end device 808 processes radio signals received through antennas 802, 804 and 806 and process signals to be transmitted via the antennas 802, 804 and 806. In one aspect of the disclosure, each RAT devices 810 and 812 includes integrated modems (i.e., first modem 826 and second modem 828). Although, the modems 826 and 828 are integral to their respective RAT devices 810 and 812, each RAT device 810 and 812 may be coupled to both the first modem 826 and the second modem 828 to facilitate dynamic selection of network operators based on a selection of multiple SIMs. In one aspect of the disclosure, the first modem 826 and the second modem 828 may be implemented on a modem port independent but coupled to each RAT device 810 or 812. In one aspect of the disclosure, the second RAT device 812 can be a modem device (e.g., a mobile station modem). The combination of the first RAT device 810 and the second RAT device 812 can be implemented according to a chip set configuration.

In operation, a connectivity engine 830 associated with the first RAT device 810 or a connectivity engine 832 associated with the second RAT device 812, may be configured to select between network operators by configuring the modems 826 and 828 in the system to coordinate to improve user experience. In some implementations, the connectivity engine 830 and 832 may be coordinated in the RAT devices 810 and/or 812, or independent but coupled to a single RAT 810 or 812 or to both RATs 810 and 812. This implementation allows for dynamic selection of network operators based on a selection of the multiple SIMs 816, 818, 822, and/or 824. The dynamic selection may be accomplished by a single modem (e.g., modem 828) implementation and/or multiple modem (e.g., modems 826 and 828) implementation. In some aspects of the disclosure, the single modem implementation may be independent of the dual modem implementation. Therefore, a UE may be configured for a single modem implementation, a dual modem implementation or both. In the single modem (e.g., mobile station modem) implementation, the second modem 828 may be coupled to the first switch 814, which is coupled to the first SIM 816 and the second SIM 818. The switch 814 enables selection of network operators associated with the first and the second SIMs 816 and 818 in accordance with the single modem 828. In the multiple modem (e.g., two modems) implementation, each of the first modem 826 and the second modem 828 may be coupled to the second switch 820, which is coupled to the third SIM 822 and the fourth SIM 824. The switch 820 enables selection of network operators associated with the third and the fourth SIMs on both the first modem 826 and the second modem 828.

The implementation of the connectivity engine with the modem configuration in conjunction with multiple SIMs allows for mapping of applications to multiple radio access technologies and network operators to increase network operator and RAT selection choices to improve performance. Thus, at a given time/location, the implementation can improve RAT/operator selection to improve performance metrics such as cost, coverage, performance and power consumption. For example, call connections/drops and overall quality of the call may be improved by selecting a network operator or RAT with the best service coverage. Other benefits include improving application performance by selecting a network operator/RAT with the highest throughput or other parameter, reducing cost by selecting a network operator/RAT with the best cost (e.g. voice/data plan) and reducing power consumption by selecting a network operator/RAT based on the distance to the BS (RF power vs. distance), which reduces power consumption. In one aspect of the disclosure, the UE includes multiple modems (e.g., two modems) associated with multiple RATs. The multiple SIMs can be multiplexed with the available modems to improve congested links. The modems being configured to support SIM swaps including software swap of universal integrated circuit card (UICC) slots and/or programmable VSIM.

FIG. 9 illustrates a system 900 for selecting between network operators based on a connectivity engine. The system 900 for selecting between network operators can be implemented in a UE 102. The system 900 for selecting between network operators can be implemented in a UE 102. The system 900 includes a first RAT device (e.g., 3GPP2 RAT (1×, DO, LTE)) 910, a second RAT device (e.g., WLAN) 911 and a third RAT device (e.g., 3GPP RAT (GPRS, HSPA, LTE) 912, multiple SIMs 916, 918, . . . , SIM N (where N is an integer), and/or the VSIM 924, a switch 914, connectivity engine 930 and an application processor/high level operating system (HLOS) 905.

In operation, a connectivity engine 930 may be configured to dynamically select between network operators base d on a selection of the multiple SIMs 916, 918, . . . , N, and/or the VSIM 924. The switch 914 enables selection of RATs corresponding to the selected network operators associated with the multiple SIMs 916, 918, . . . , N, and/or the VSIM 924. The implementation of the connectivity engine in conjunction with multiple SIMs allows for mapping of applications to multiple radio access technologies and network operators to increase network operator and RAT selection choices to improve performance.

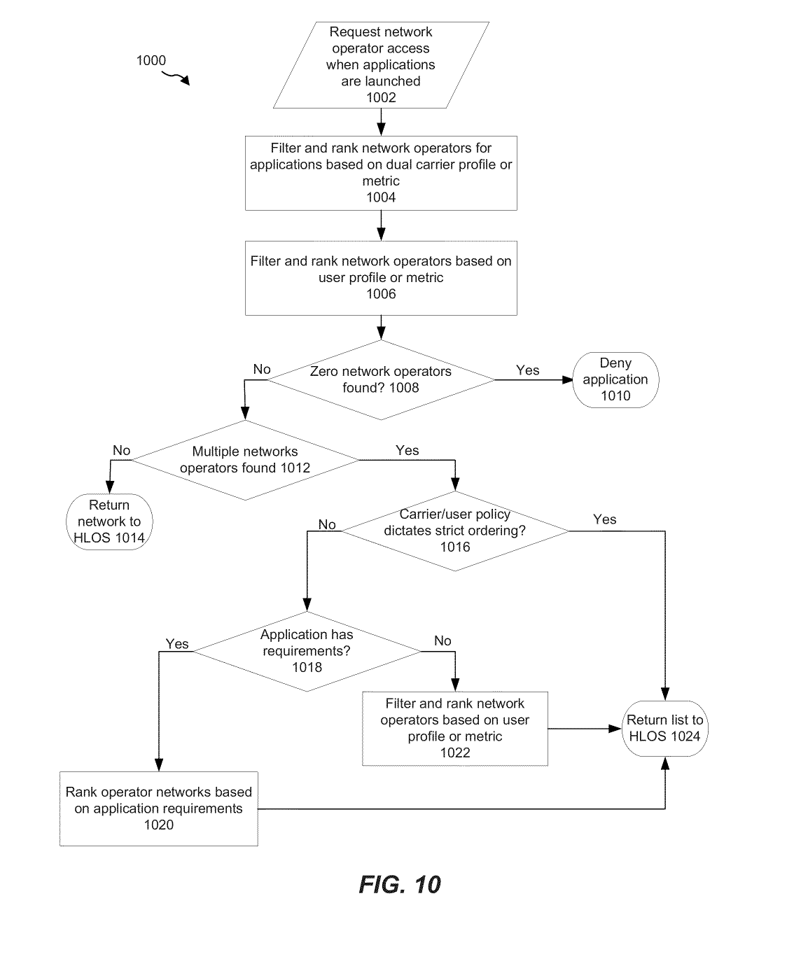

FIG. 10 illustrates a network operator selection implementation 1000 according to one aspect of the present disclosure. The network operator selection implementation 1000 may be implemented according to a DSDA configuration. At block 1002, an operator network access for one or more launched applications is requested. At block 1004, the operator networks are filtered and ranked for the launched applications based on dual carrier profiles. At block 1006, the operator networks are filtered and ranked based on user profiles or metrics (e.g., battery, cost). At block 1008, it is determined whether one or more network operators are found. When one or more network operators are found at block 1008, the implementation continues to block 1012 where it is determined whether multiple network operators are found. Otherwise, the implementation continues to block 1010 where the launched application is denied. When multiple network operators are found at block 1012, the implementation continues to block 1016 where it is determined whether a carrier/user policy dictates strict ordering. Otherwise, the implementation returns the network to the high level operating system (HLOS) at block 1014. When a carrier/user policy dictates strict ordering at block 1016, the implementation returns a list of network operators to the HLOS at block 1024. Otherwise, the implementation continues to block 1018 where it is determined whether the application includes a requirement (e.g., a metric such as bandwidth). When it is determined that the application includes a requirement at block 1018, the implementation ranks the network operators for the application based on the metric requirement at block 1020 and then continues to block 1024. Otherwise, the implementation ranks the network operators for the application based on a WLAN preference (e.g., carrier WiFi, home SSID) and then continues to block 1024.

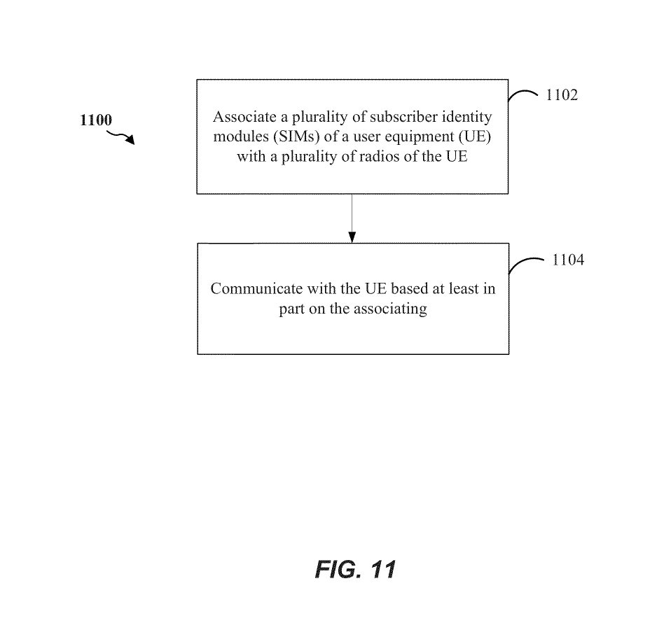

As shown in FIG. 11, an apparatus, such as a connectivity engine, modem and/or switching device of a UE, may associate a plurality of SIMs of the UE with a plurality of radios of the UE, as shown in block 1102. The apparatus may communicate with the UE based at least in part on the associating.

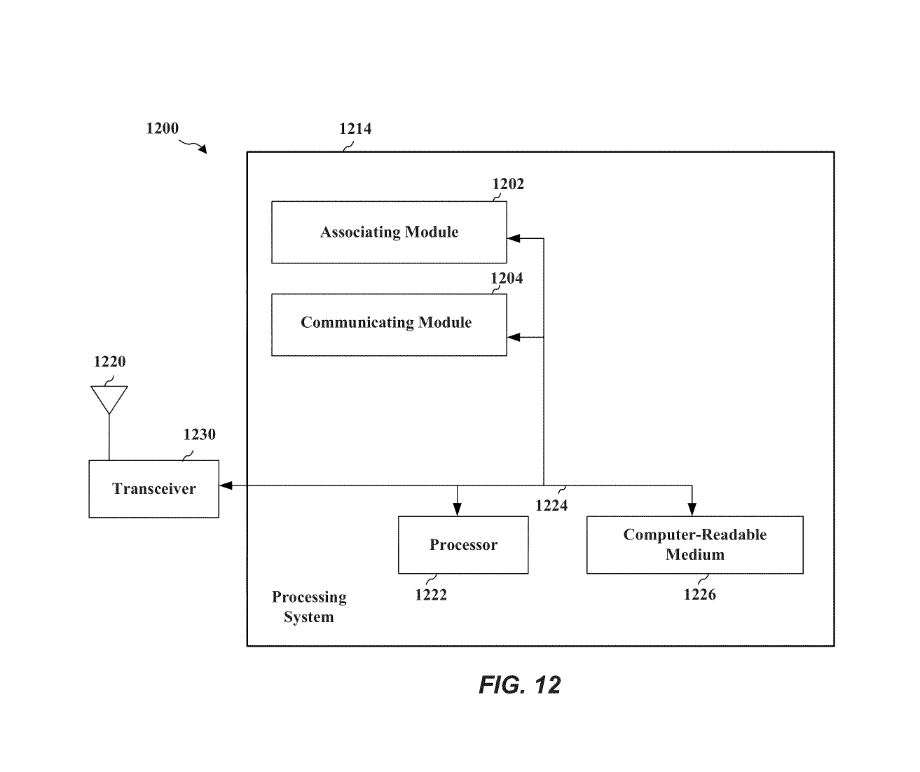

FIG. 12 is a diagram illustrating an example of a hardware implementation for an apparatus 1200 employing a dynamic network operator selection system 1214. The dynamic network operator selection system 1214 may be implemented with a bus architecture, represented generally by a bus 1224. The bus 1224 may include any number of interconnecting buses and bridges depending on the specific application of the dynamic network operator selection system 1214 and the overall design constraints. The bus 1224 links together various circuits including one or more processors and/or hardware modules, represented by a processor 1222, an associating module 1202 and a communicating module 1204, and a computer-readable medium 1226. The bus 1224 may also link various other circuits such as timing sources, peripherals, voltage regulators, and power management circuits, which are well known in the art, and therefore, will not be described any further.

The apparatus includes the dynamic network operator selection system 1214 coupled to a transceiver 1230. The transceiver 1230 is coupled to one or more antennas 1220. The transceiver 1230 provides a means for communicating with various other apparatus over a transmission medium. The dynamic network operator selection system 1214 includes the processor 1222 coupled to the computer-readable medium 1226. The processor 1222 is responsible for general processing, including the execution of software stored on the computer-readable medium 1226. The software, when executed by the processor 1222, causes the dynamic network operator selection system 1214 to perform the various functions described supra for any particular apparatus. The computer-readable medium 1226 may also be used for storing data that is manipulated by the processor 1222 when executing software. The dynamic network operator selection system 1214 further includes the associating module 1202 for associating a plurality of SIMs of a UE with a plurality of radios of the UE and the communicating module 1204 for communicating with the UE based at least in part on the associating. The associating module 1202 and the communicating module 1204 may be software modules running in the processor 1222, resident/stored in the non-transitory computer-readable medium 1226, one or more hardware modules coupled to the processor 1222, or some combination thereof. The dynamic network operator selection system 1214 may be a component of the UE 102 and may include the memory 682 and/or the controller/processor 680.

In one configuration, the apparatus 1200 for wireless communication includes means for associating. The means may be the UE 102/206, controller/processor 680, memory 682, connectivity engine 830/832, RAT device 810/812, modem 826/828, switch 814/820, associating module 1202 and/or the dynamic network operator selection system 1214 of the apparatus 1200 configured to perform the functions recited by the associating means. As described above, the dynamic network operator selection system 1214 may be a component of the UE 102 and may include the memory 682 and/or the controller/processor 680. In another aspect, the aforementioned means may be any module or any apparatus configured to perform the functions recited by the aforementioned means.

In one configuration, the apparatus 1200 for wireless communication includes means for communicating. The means may be the UE 102/206, the antenna 652, transmit processor 664, connectivity engine 830/832, RAT device 810/812, modem 826/828, communicating module 1204 and/or the dynamic network operator selection system 1214 of the apparatus 1200 configured to perform the functions recited by the means. As described above, the dynamic network operator selection system 1214 may be a component of the UE 102 and may include the memory 682 and/or the controller/processor 680. In another aspect, the aforementioned means may be any module or any apparatus configured to perform the functions recited by the aforementioned means.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory computer-readable storage medium known in the art. An exemplary non-transitory computer-readable storage medium is coupled to the processor such that the processor can read information from, and write information to, the storage medium. In the alternative, the non-transitory computer-readable storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. A non-transitory computer-readable storage media may be any available media that can be accessed by a general purpose or special purpose computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable storage media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
associating a plurality of subscriber identity modules (SIMs) of a user equipment (UE) with a plurality of radios of the UE; and
communicating with the UE based at least in part on the associating.

2. The method of claim 1, wherein:
associating a plurality of subscriber identity modules (SIMs) of a user equipment (UE) with a plurality of radios of the UE comprises associating at least two SIMs to communicate using a single radio of the UE; and
communicating with the UE based at least in part on the associating comprises communicating with each of the at least two SIMs on the single radio.

3. The method of claim 1, wherein communicating with the UE based at least in part on the associating comprises simultaneously communicating with two or more networks.

4. The method of claim 1, wherein at least one of the plurality of SIMs is implemented according to a virtual SIM configuration.

5. The method of claim 1, wherein associating a plurality of subscriber identity modules (SIMs) of a user equipment (UE) with a plurality of radios of the UE is based at least in part on improving a communication metric.

6. The method of claim 5, wherein the communication metric comprises at least one of cost, network coverage, network congestion, network interference, unified billing, quality of service, bandwidth, WiFi offload efficiency and/or device power consumption.

7. The method of claim 6, wherein the device power consumption is based at least in part on a per-radio (RAT) power consumption and/or per-operator power consumption based on transmit power to cover a distance to a serving base station.

8. The method of claim 5, wherein the communication metric comprises an operator selection based on in-device radio access technology coexistence.

9. The method of claim 5, wherein the communication metric comprises at least one of an operator selection based on one or more policies per operator, an operator selection based on one or more overall user policies that manage overall UE behavior, an operator selection based on time-of-day and operator selection based on a per-application operation specification.

10. An apparatus for wireless communication, comprising:
means for associating a plurality of subscriber identity modules (SIMs) of a user equipment (UE) with a plurality of radios of the UE; and
means for communicating with the UE based at least in part on the associating.

11. The apparatus of claim 10, wherein:
means for associating a plurality of subscriber identity modules (SIMs) of a user equipment (UE) with a plurality of radios of the UE comprises means for associating at least two SIMs to communicate using a single radio of the UE; and
means for communicating with the UE based at least in part on the associating comprises means for communicating with each of the at least two SIMs on the single radio.

12. The apparatus of claim 10, wherein means for communicating with the UE based at least in part on the associating comprises means for simultaneously communicating with two or more networks.

13. The apparatus of claim 10, further comprising means for implementing at least one of the plurality of SIMs according to a virtual SIM configuration.

14. The apparatus of claim 10, wherein means for associating a plurality of subscriber identity modules (SIMs) of a user equipment (UE) with a plurality of radios of the UE comprises means for associating based at least in part on improving a communication metric.

15. The apparatus of claim 14, wherein the communication metric comprises at least one of cost, network coverage, network congestion, network interference, unified billing, quality of service, bandwidth, WiFi offload efficiency and device power consumption.

16. An apparatus for wireless communication, comprising:
a memory; and
at least one processor coupled to the memory and configured to perform operations comprising:
associating a plurality of subscriber identity modules (SIMs) of a user equipment (UE) with a plurality of radios of the UE; and
communicating with the UE based at least in part on the associating.

17. The apparatus of claim 16, wherein the at least one processor is configured to perform operations such that:
associating a plurality of subscriber identity modules (SIMs) of a user equipment (UE) with a plurality of radios of the UE comprises by associating at least two SIMs to communicate using a single radio of the UE; and
communicating with the UE based at least in part on the associating comprises communicating with each of the at least two SIMs on the single radio.

18. The apparatus of claim 16, wherein the at least one processor is further configured to perform operations such that communicating with the UE based at least in part on the associating comprises simultaneously communicating with two or more networks.

19. The apparatus of claim 16, wherein the at least one processor is further configured to perform operations further comprising implementing at least one of the plurality of SIMs according to a virtual SIM configuration.

20. The apparatus of claim 16, wherein the at least one processor is further configured to perform operations such that associating a plurality of subscriber identity modules (SIMs) of a user equipment (UE) with a plurality of radios of the UE comprises associating based at least in part on improving a communication metric.

21. The apparatus of claim 20, wherein the at least one processor is further configured to perform operations such that the communication metric comprises at least one of cost, network coverage, network congestion, network interference, unified billing, quality of service, bandwidth, WiFi offload efficiency and device power consumption.

22. The apparatus of claim 21, wherein the at least one processor is further configured to perform operations such that the device power consumption is based at least in part on a per-radio (RAT) power consumption and/or per-operator power consumption based on transmit power to cover a distance to a serving base station.

23. The apparatus of claim 20, wherein the at least one processor is further configured to perform operations such that the communication metric comprises an operator selection based on in-device radio access technology coexistence.

24. The apparatus of claim 20, wherein the at least one processor is further configured to perform operations such that the communication metric comprises at least one of an operator selection based on one or more policies per operator, an operator selection based on one or more overall user policies that manage overall UE behavior, an operator selection based on time-of-day and operator selection based on per-application operation specification.

25. A computer program product for wireless communications in a wireless network, comprising:
a non-transitory computer-readable medium having program code recorded thereon, the program code comprising:
program code to associate a plurality of subscriber identity modules (SIMs) of a user equipment (UE) with a plurality of radios of the UE; and
program code to communicate with the UE based at least in part on the associating.

26. The computer program product of claim 25, wherein the program code to associate a plurality of subscriber identity modules (SIMs) of a user equipment (UE) with a plurality of radios of the UE comprises program code to associate at least two SIMs to communicate using a single radio of the UE, and wherein the code to communicate with the UE based at least in part on the associating comprises program code to communicate with each of the at least two SIMs on the single radio.

27. The computer program product of claim 25, wherein the code to communicate with the UE based at least in part on the associating comprises program code to simultaneously communicate with two or more networks.

28. The computer program product of claim 25, wherein the program code further comprises program code implement at least one of the plurality of SIMs according to a virtual SIM configuration.

29. The computer program product of claim 25, wherein the program code to associate a plurality of subscriber identity modules (SIMs) of a user equipment (UE) with a plurality of radios of the UE comprises program code to associate the plurality of SIMs of a UE with a plurality of radios of the UE based at least in part on improving a communication metric.
